(19) United States
(12) Patent Application Publication
(10) Pub. No.: US 2023/0266464 A1
(43) Pub. Date: Aug. 24, 2023

(54) ADAPTIVE PROXIMITY DETECTION SYSTEM

(71) Applicant: ams International AG, JONA (CH)

(72) Inventors: Vasanth Swaroop YADAGIRI, Plano, TX (US); Ravi Kumar ADUSUMALLI, Secunderabad (IN)

(73) Assignee: ams International AG, JONA (CH)

(21) Appl. No.: 18/005,229

(22) PCT Filed: Jun. 15, 2021
(86) PCT No.: PCT/EP2021/066134

§ 371 Date: Jan. 12, 2023

Related U.S. Application Data
(60) Provisional application No. 63/052,211, filed on Jul. 15, 2020.

(51) Int. Cl. G01S 17/04; G01S 7/484; G01S 7/487; H04M 1/21

(52) U.S. Cl. CPC G01S 17/04; G01S 7/484; G01S 7/4873; H04M 1/21

(57) ABSTRACT

A proximity detection system for a mobile device. The system includes an infrared emitter to emit infrared light, an infrared detector to detect the infrared light after reflection from a target and provide a detector signal; and a signal processing subsystem. The signal processing subsystem is configured to control the proximity detection system into a first, detect mode for detecting proximity of the target as the target approaches the mobile device, and after detection of the target to control the proximity detection system into a second, release mode for detecting movement of the target out of proximity to the mobile device. The signal processing subsystem also controls the proximity detection system such that, contrary to conventional hysteresis, for a given proximity of the target the detector signal reduces when the mode switches from the detect mode to the release mode, thus increasing reliability.

### CROSS-REFERENCE TO RELATED APPLICATIONS

The present application is the national stage entry of International Patent Application No. PCT/EP2021/066134, filed on Jun. 15, 2021, and published as WO 2022/012833 A1 on Jan. 20, 2022, which claims the benefit of U.S. Provisional Pat. Application No. 63/052,211, filed on Jul. 15, 2020, the disclosures of all of which are incorporated by reference herein in their entireties.

### FIELD

This specification relates to proximity detection systems for mobile devices.

### BACKGROUND

Mobile phones typically incorporate a proximity sensor to disable the display and touch sensing when a user lifts the phone to their ear. These normally use infrared light to sense proximity of the user’s head by reflection, but optical noise is a problem. One type of optical noise is flicker from grid mains powered lighting. Another source of noise is shot noise in high ambient light conditions. Normally shot noise is prominent at low light levels when single photons are counted, but shot noise increases with light level especially when integration periods are short. As signal level increases shot noise in the signal becomes relatively less, but in a proximity detector where reflected infrared light is being detected shot noise from the ambient (infrared) light can be a problem at high ambient light levels and short integration periods.

There is a general need to increase the reliability of proximity detection systems for mobile devices. As described later, there are particular problems when the proximity sensor is behind the mobile phone display, which is otherwise desirable for aesthetic reasons e.g. to reduce or remove the mobile phone notch.

General background prior art can be found in: US2014/252212, US8692200, and US9608132.

### SUMMARY

In one aspect there is therefore described a proximity detection system for a mobile device. The proximity detection system comprises an infrared emitter to emit infrared light, an infrared detector to detect the infrared light after reflection from a target and to provide a detector signal; and a signal processing subsystem. The signal processing subsystem is configured to control the proximity detection system into a first, detect mode for detecting proximity of the target as the target approaches the mobile device, and after detection of the target to control the proximity detection system into a second, release mode for detecting movement of the target out of proximity to the mobile device. The signal processing subsystem is also configured to control the proximity detection system such that for a given proximity of the target the detector signal reduces when the mode switches from the detect mode to the release mode.

Some implementations increase the reliability of the system by increasing a difference between the detect and release thresholds, more specifically by reducing the detector signal when the mode switches to the release mode (counter-intuitively, the reverse of conventional hysteresis). Thus the system increases a ratio of this difference to the detector signal noise, the detector signal noise depending in part on the ambient light shot noise. An effect of this is to reduce the number of false target detect/release events. This is generally useful but can be particularly important when the proximity sensor is behind a display, e.g. a mobile phone display, and there is attenuation by the display stack.

In some implementations the infrared emitter is controlled to emit a first level of optical energy in the detect mode and a second, lower level of optical energy in the release mode. Here optical energy refers to optical energy, or power, averaged over a period of time. For example the optical energy may be controlled by controlling a drive level, e.g. drive current, to the infrared emitter, and/or a number of optical pulses from the infrared emitter, and/or a pulse length of infrared light from the infrared emitter, and/or a number of infrared emitters, if there multiple infrared emitters are present. In implementations the signal processing subsystem is programmable to control one or more of these factors to control the optical energy. In a similar way in implementations the detector signal responds to the average optical energy, or average power, e.g. by integrating the detected infrared light over a detector integration time. Also or instead the detector signal may be reduced by reducing a gain of analogue or digital signal processing circuitry processing an output from the infrared detector.

In some implementations the proximity detection system may interface with the mobile device, more particularly with device software such as an application or the operating system running on the mobile device, using a handshaking protocol. This can help to synchronise the operation of the proximity detection system and the device software.

More particularly, the signal processing subsystem may be configured to generate a proximity detect signal for the mobile device on detection of proximity of the target, to enable the mobile device to perform an action i.e. a post-detect action. In some implementations the signal processing subsystem is configured to control the proximity detection system into the release mode only after receiving a signal, e.g. a release enable signal, from the device software that indicates that the post-detect action has been performed by the mobile device e.g. in response to the signal. When the proximity detection system is in its release mode it may be switched back into the detect mode after receiving a signal, e.g. a detect enable signal, from the device software that indicates that an action, i.e. a post-release action, has been performed by the mobile device. In some other approaches the proximity detection system may be switched back into the detect mode after a time period. The device software may signal to the proximity detection system by controlling a value in a register of the system.

In some implementations the proximity detect signal is a detect interrupt signal generated by the signal processing system for the mobile device e.g. an interrupt signal generated by the signal processing subsystem for a processor of the mobile device. The signal processing subsystem may also be configured to generate a release interrupt signal for the mobile device, similarly an interrupt signal generated by the signal processing subsystem for a processor of the mobile device, when the proximity detection system detects movement of the target out of proximity to the mobile device. This can simplify interfacing between the proximity detection system and the mobile device.

The proximity detection system may generate a proximity detect signal and/or a corresponding release signal e.g. as previously described but this is not essential. For example in some implementations the device software may interrogate a value dependent upon the detector signal e.g. in a register of the proximity detection system.

In some implementations the proximity detection system is configured to store one or both of a detect threshold value and a release threshold value in a respective programmable detect threshold register or programmable release threshold register. The signal processing subsystem may then be configured to compare a value derived from the detector signal with a value in the detect threshold register and/or a value in the release threshold register to generate the proximity detect signal or a corresponding release signal. Providing an ability to program these thresholds enables a user to configure the system for a target (maximum) failure rate, that is a target false detect/false release rate, as described in detail later.

In some mobile device applications there can be crosstalk between the infrared emitter and detector. For example particularly but not exclusively this can be a problem when one or both of these are located behind a display. Further, because the effective sensitivity of the system is different in the detect and release modes the crosstalk may also be different in each mode.

Thus in some implementations the proximity detection system is configured to store a crosstalk calibration value for each of the detect mode and the release mode. An analogue front end or the signal processing subsystem may then be configured to apply the respective crosstalk calibration value to the detector signal (or value derived therefrom) in each of the detect mode and the release mode. This may be done e.g. by applying an offset to the detector signal (or value derived therefrom) based on the respective crosstalk calibration value. The proximity detection system, in particular the signal processing subsystem, may automatically apply the appropriate crosstalk calibration value according to the mode of operation.

In some applications the mobile device, e.g. mobile phone, has an OLED (organic light emitting diode) display and one or both of the infrared emitter and the infrared detector is located behind the OLED display. The techniques describes herein are particularly useful for such applications, as the display stack optical transmissivity may be low and reliable operation in high ambient light conditions can be challenging. A potential further advantage is that an optical power of the infrared emission may be lower than would otherwise be needed, reducing screen distortion: shining IR light through an OLED display stack can cause OLED pixels to light up resulting in display distortion/artefacts.

One use of the proximity detection system is to detect when a user brings a mobile phone up to their ear to make a call, so that the display can be blanked and/or touch sensing disabled during the call and re-established thereafter. Thus the target detected by the system may be a user’s head.

In another aspect a method of detecting proximity of a target to a mobile device using a proximity detection system comprises illuminating the target with infrared light from an infrared emitter, detecting reflected light from the target to provide a detector signal, detecting proximity of the target to the mobile device using the detector signal, then controlling the proximity detection system to reduce the detector signal, and detecting movement of the target out of proximity to the mobile device.

As previously described in some implementations controlling the proximity detection system to reduce the detector signal comprises or consists of reducing an optical energy output from the infrared emitter. As previously described, detecting when the target moves into/out of a defined proximity to the emitter/detector may comprise comparing a value derived from the detector signal with different detect and release thresholds.

The method may involve setting a difference between the detect threshold and the release threshold to define a false trigger rate of the proximity detection system. The false trigger rate may define a probability of a false detect and/or false release of the target into/from the defined proximity.

A difference between the detect threshold and the release threshold may be used to define a proximity ratio, Pᵣ, according to:

$${P}_{r} = \frac{\left(d e t e c t t h r e s h o l d\right) - \left(r e l e a s e t h r e s h o l d\right)}{6 σ}$$

where σ is the RMS (root mean square) noise level of the detector signal. Setting the difference between the detect threshold and the release threshold to define the false trigger rate may then comprise selecting a value for Pᵣ according to

$${P}_{r} = \frac{N}{C}$$

where N is a number of standard deviations of a distribution of the noise in the detector signal that defines a probability of false trigger, or p-value, corresponding to the false trigger rate and C is a constant between 1 and 5 e.g. between 2.5 and 3.5. The distribution may be assumed to be Gaussian. The value of C depends on an assumed relationship between peak-to-peak and RMS noise. For example the peak-to-peak noise may be taken as 6σ or 6.6σ but depends on an assumed time scale of measurement (the longer the time scale the greater the peak-to-peak noise).

Aspects of the above described system, in particular the signal processing subsystem, may be implemented in dedicated hardware i.e. electronic circuitry e.g. on one or more integrated circuits, or in software controlling one or more processors, using a combination of software and hardware. In this specification the phrase “configured to” is to be interpreted accordingly.

Thus computer-readable instructions may implement a system and method as described above, in particular the signal processing. The computer-readable instructions may be stored on one or more computer readable media e.g. one or more physical data carriers such as a disk or programmed memory such as non-volatile memory (e.g. Flash) or read-only memory. Code and/or data to implement examples of the system/method may comprise source, object or executable code in a conventional programming language, interpreted or compiled, such as C, or assembly code, or code for a hardware description language. The code and/or data may be distributed between a plurality of coupled components in communication with one another.

Details of these and other aspects of the system are set forth below, by way of example only.

### BRIEF DESCRIPTION OF THE DRAWINGS

FIGS. 1a and 1b show, respectively, a block diagram of an example proximity detection system for a mobile device, and example locations of an infrared emitter and infrared detector.

FIG. 2 shows an example flow diagram of a proximity detection method;

FIGS. 3a and 3b illustrate operation of the proximity detection system.

FIG. 4 shows a flow diagram of an example method of configuring the proximity detection system.

FIG. 5 shows a graph illustrating error tolerance against ambient light.

Like reference numerals indicate like elements.

### DETAILED DESCRIPTION

This specification describes a proximity detection system for a mobile device, for example a proximity detection system for a mobile phone to detect proximity of a user’s head. Implementations of the system have a reduced false trigger rate compared to conventional approaches.

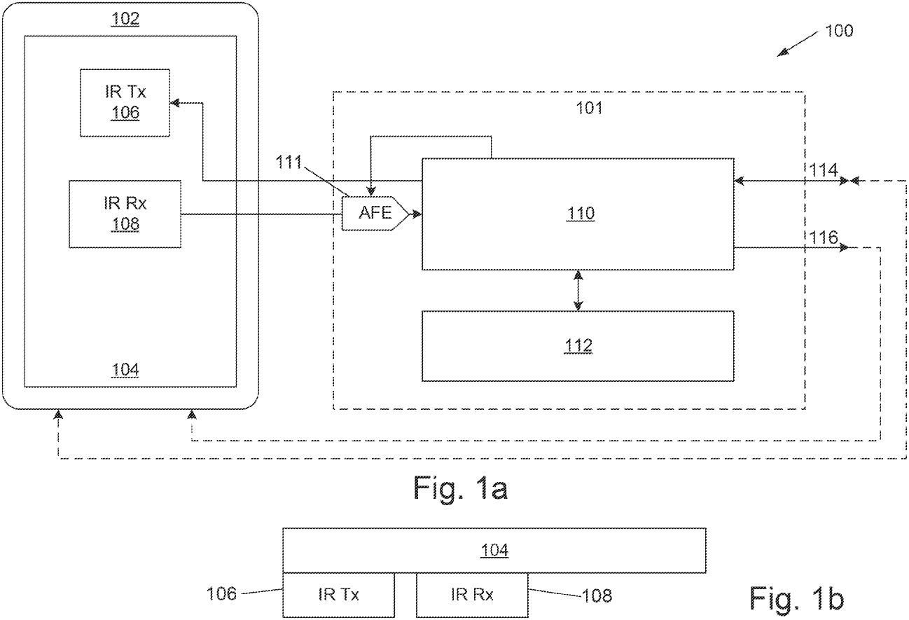

FIG. 1a shows a proximity detection system 100 coupled to a mobile device 102. The proximity detection system 100 is shown separate to the mobile device 102 for convenience but would typically be incorporated into the mobile device.

The proximity detection system 100 includes an infrared (IR) emitter 106, an infrared detector 108. The infrared (IR) emitter 106 may be an LED (Light Emitting Diode) or VCSEL (Vertical Cavity Surface Emitting Laser). In this specification infrared light may be light with a wavelength of >700 nm, it may have a wavelength <3000 nm; as an example only, around 940 nm.

One or both of the infrared (IR) emitter 106 and infrared detector 108 may be located behind a display 104 e.g. an OLED display of the mobile device as shown in FIG. 1b. In this location IR-blocking parts of the display stack, such as protective barriers or metallization, may be locally removed. In some other configurations one or both of the infrared emitter 106 and infrared detector 108 may be located behind a bezel between the display stack and a device frame.

The proximity detection system 100 includes proximity detection processing 101 which comprises a signal processing subsystem 110 coupled to a set of programmable registers 112. In some implementations these may be on a single integrated circuit. The proximity detection processing 101 provides a drive to the IR emitter 106 and receives an input from the IR detector 108 via an analogue front end 111 e.g. including an analogue-to-digital converter (ADC).

The analogue front end 111 provides a detector signal to the signal processing subsystem 110 representing an optical energy detected by the IR detector 108. The detector signal may represent a time-integrated optical energy e.g. where the IR emitter produces multiple pulses. For example the detector signal may be integrated over a detector integration time e.g. on an integration capacitor. A gain of the analogue front end 111 may be controlled by the signal processing subsystem 110.

The signal processing subsystem 110 has two modes of operation, a detect mode and a release mode, and in operation switches between the two as described later.

The drive to the IR emitter 106 is controlled by the proximity detection processing 101 such that, for a particular target proximity, the detector signal is greater in the detect mode than in the release mode. In implementations an optical (IR) energy output from the emitter is greater in the detect mode than in the release mode. For example signal processing subsystem 110 may control the drive to the IR emitter 106 such that one or more of a drive current, a drive pulse duration, and a number of drive pulses, is greater in the detect mode than in the release mode. The gain of the analogue front end 111 may also be controlled to be lower in the release mode than in the detect mode.

The programmable registers 112 may store configuration data to configure the optical (IR) energy output and/or analogue front end for the detect mode and for the release mode. The configuration data may comprise, for each mode, data defining one or more of: the drive current, the drive pulse duration, the number of drive pulses, and the gain of the analogue front end.

The programmable registers 112 may also store calibration and threshold values. In particular the programmable registers 112 may comprise a programmable detect threshold register and a programmable release threshold register to store respective detect and release threshold values for the detect and release modes. The programmable registers 112 may also comprise a calibration value register for each of the detect and release modes, to store a respective crosstalk calibration value for each mode.

As well as programmable registers 112 the proximity detection processing 101 may include a detector signal register storing a value representing the detector signal i.e. a detected level of infrared optical energy.

The signal processing subsystem 110 also provides an interface to the mobile device e.g. comprising data and/or clock signals 114 for reading from or writing to registers of the signal processing subsystem 110. The interface may also provide one or more interrupt outputs 116 for interrupting a processor of the mobile device.

In some implementations the infrared emitter 106, infrared detector 108, and proximity detection processing 101 may be combined in a single integrated circuit; in others the infrared emitter 106 and infrared detector 108 may be separate.

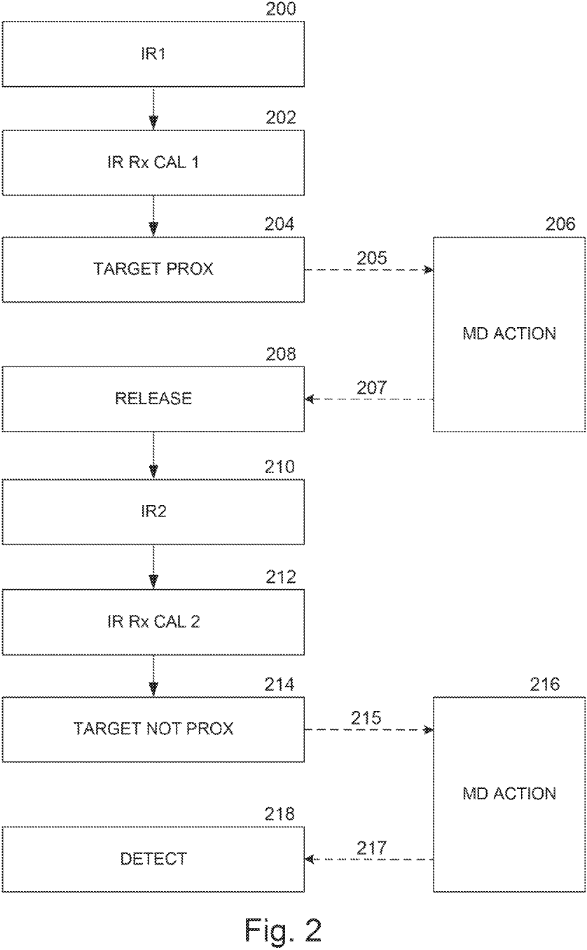

FIG. 2 shows a flow diagram illustrating operation of the proximity detection system 100. The process begins with the signal processing subsystem 110 in the detect mode (step 200), in which the drive to the IR emitter 106 is set at a first level to set a first IR light output.

The IR detector 108 detects a first level of IR light reflected by the target to generate the detector signal. The signal processing subsystem 110 may apply an offset value, P_{offset} for the detect mode, to the detector signal to cancel crosstalk between the IR emitter 106 and IR detector 108 i.e. light which reaches the IR detector 108 without having been reflected by the target.

The value of P_{offset} may be read from the programmable registers 112 and in implementations a different value of P_{offset} is used in the detect mode and in the release mode, e.g. P_{offset_detect} and P_{offset_release}. The offset value may be applied to the detector signal by subtracting the offset, or by adding a negative offset.

For example when the IR emitter and detector are behind the display the offset arises primarily from reflection within the display stack, and this signal component may be subtracted off. The level of reflection is different in the two modes because the level of optical energy output from the IR emitter is different. The values of P_{offset_detect} and P_{offset_release} may be determined using a separate calibration procedure for each optical (IR) energy output e.g. at manufacture per device or for a type of device, or at some other later time e.g. when there is no target nearby, optionally in the dark.

Thus at step 202 the system detects the reflected light, and may then read a first crosstalk calibration value, P_{offset_detect}, from the calibration value register for the detect mode, and apply the first crosstalk calibration value to a value derived from the detector signal. The system may then store the corrected value in the detector signal register.

As a target approaches the IR emitter 106 and IR detector 108 an amount of IR light reflected by the target onto the IR detector 108 increases and the detector signal increases accordingly. The signal processing subsystem 110 compares the detector signal, e.g. the corrected value in the detector signal register, with a detect threshold value in the detect threshold register to detect proximity of the target, i.e. when the target is at a threshold proximity, when the detect threshold value is reached (step 204).

The detected proximity generally corresponds to a distance of the target from the IR emitter 106 and IR detector 108, but the detected proximity may also depend on other factors e.g. a reflectance of the target.

When proximity of the target is detected the signal processing subsystem 110 system changes from the detect mode to the release mode. However in some implementations the system communicates with the mobile device to determine when to change mode.

More particularly in some implementations the mode change is not performed by the signal processing subsystem 110 until it has received confirmation from a processor of the mobile device that a post (target)-detect action has been performed. For example the post-detect action may be to turn off the display or touch sensing on the display.

Thus at step 204, on detection of proximity of the target the system may generate a proximity detect signal 205 to signal the detection to the processor of the mobile device. The proximity detect signal may comprise a flag e.g. a bit set in one of the registers of the signal processing subsystem 110. Also or instead a detect interrupt signal may be generated.

The mobile device may then perform the post-detect action (step 206) and generate a release enable signal 207 indicating that the post-detect action has been performed. The signal processing subsystem 110 may wait for the release enable signal then select the release mode (step 208).

When it enters the release mode the signal processing subsystem 110 sets the drive to the IR emitter 106 at a second level to set a second IR light output lower than the first IR light output (step 210).

The system detects the reflected light, and may then read a second crosstalk calibration value, P_{offset_release}, from the calibration value register for the release mode, and apply the second crosstalk calibration value to a value derived from the detector signal (step 212). The system may then store the corrected value in the detector signal register.

The value in the detector signal register is reduced when the system is in the release mode, but the release threshold value is lower than the detect threshold value so release is not triggered immediately.

As the target moves out of proximity i.e. moves away from the IR emitter 106 and IR detector 108, the amount of IR light reflected by the target onto the IR detector 108 decreases and the detector signal decreases accordingly. The signal processing subsystem 110 compares the detector signal, e.g. the corrected value in the detector signal register, with a release threshold value in the release threshold register to detect movement of the target out of proximity when the release threshold value is reached (step 214).

When release of the target is detected the signal processing subsystem 110 system changes from the release mode back to the detect mode. However in some implementations the mode change is not performed by the signal processing subsystem 110 until it has received confirmation from a processor of the mobile device that a post (target)-release action has been performed. For example the post-release action may be to turn on the display or touch sensing on the display.

Thus at step 214, on detection of movement of the target out of proximity the system may generate a release detect signal 215 to signal the release to the processor of the mobile device. The release detect signal may comprise a flag e.g. a bit reset in one of the registers of the signal processing subsystem 110. Also or instead a release interrupt signal may be generated.

The mobile device may then perform a post-release action (step 216) and generate a detect enable signal 217 indicating that the post-release action has been performed. The signal processing subsystem 110 may wait for the detect enable signal then select the detect mode (step 218).

When it re-enters the detect mode the signal processing subsystem 110 sets the drive to the IR emitter 106 back to the first level to reset to the first IR light output.

A proximity ratio, Pᵣ, can be defined as

$${P}_{r} = \frac{\left(d e t e c t t h r e s h o l d\right) - \left(r e l e a s e t h r e s h o l d\right)}{6 σ}$$

where σ is the RMS (root mean square) noise level of the detector signal and 6σ is one measure of the peak-to-peak noise. Broadly, a larger proximity ratio corresponds to a reduced false trigger rate.

One way to increase the proximity ratio would be to decrease the noise, i.e. the denominator. This may be done by decreasing the thermal noise, but this requires decreasing the photodiode area and/or increasing an integrator circuit output capacitance and integration time. Moreover at high ambient light levels the system noise is dominant by shot noise and reducing the thermal noise does not help. The shot noise can be reduced by integrating the detected light over a longer duration but this is not always practical or desirable.

False triggers are a particular problem in a mobile device in which the IR emitter is behind the display. IR transmission of the display stack may only be around e.g. 2%, and the very small reflected light signal from the IR detector means that noise or a slight change in the reflected signal can easily result in a false release indication. Increasing the proximity ratio can address this, and one solution would be to increase the light energy output from the IR emitter, but as previously mentioned this can lead to on-screen distortion as the IR illumination can affect OLED behaviour.

Implementations of the described proximity detection system therefore increase the numerator, increasing the difference between the detect threshold value and release threshold value. This may be done by decreasing the infrared optical energy output of the IR emitter and/or by decreasing the analogue front end gain in the release mode; or equivalently by increasing the infrared optical energy output of the IR emitter in the detect mode. In both cases the detector signal is greater in the detect mode than in the release mode.

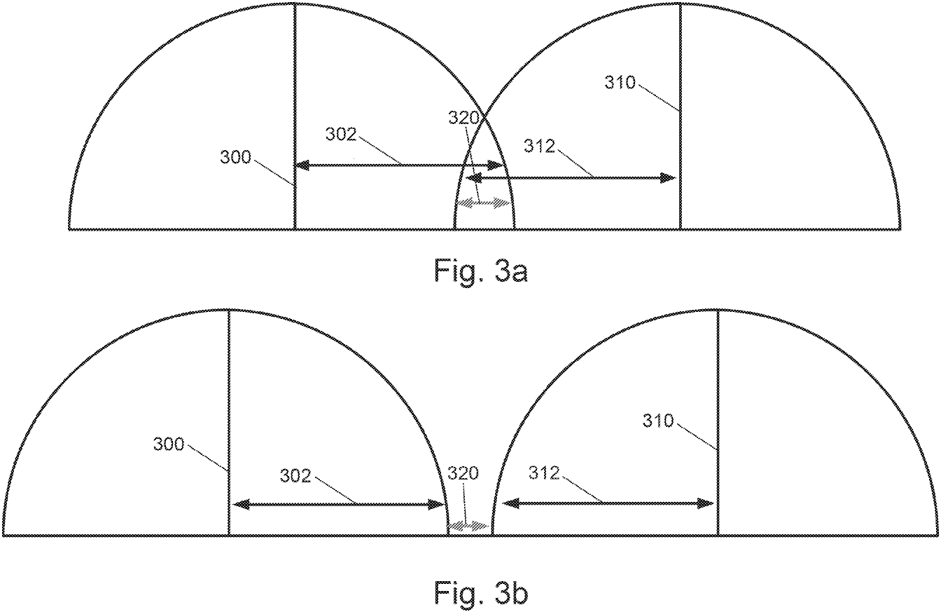

FIGS. 3a and 3b illustrates operating of the proximity detection system and the increased noise immunity. Each figure shows the detect threshold value 310 and release threshold value 300 and a diagrammatic illustration of the respective 6σ (peak-to-peak) noise 312, 302. A difference between 6σ (peak-to-peak) noise in each figure is represented by line 320. In FIG. 3a the 6σ (peak-to-peak) noise for the detect and release threshold values overlaps and false triggers can be expected to result whereas in FIG. 3b there is no overlap and no false triggers are expected for 6σ (peak-to-peak) noise.

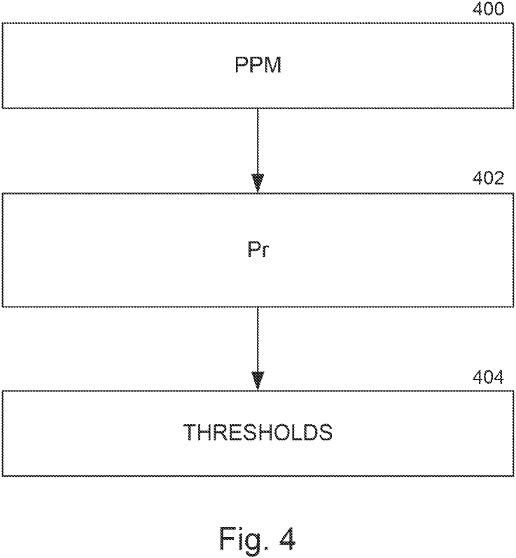

FIG. 4 shows an example process for setting the detect threshold value and release threshold value for a particular false trigger rate.

Initially a false trigger rate may be defined (step 400), for example as a probability of false trigger, or p-value, corresponding to the false trigger rate expressed as a number N of standard deviations of a distribution of the noise in the detector signal. For example a target failure rate of 0.1 ppm (parts per million) corresponds to N = 5.32. This conversion may be obtained e.g. from a standard normal table (z-table).

A value for the proximity ratio may then be determined (step 402) from

$${P}_{r} = \frac{N}{C}$$

where e.g. C = 3 for 6σ (peak-to-peak) noise. This follows from FIGS. 3a,3b where for no false triggers, and assuming that the RMS detector signal noise is the same for both detect and release modes:

$$d e t e c t t h r e s h o l d v a l u e - N σ > r e l e a s e t h r e s h o l d v a l u e + N σ$$

and hence 3Pᵣ > N. Continuing the foregoing example for N = 5.32, Pᵣ > 1.77.

The proximity ratio may then be used to determine values for the detect and release threshold values (step 404). This step depends on the specific parameters of the application and the detector RMS noise level. This is illustrated below with a particular example.

Consider an arrangement in which the drive current of a BOLED (Behind the OLED) IR emitter is varied to vary the optical energy output. Given a detector signal noise level e.g. by assuming lighting conditions such as strong ambient sunlight (110 K lux), and a target proximity ratio, in each of the detect and release modes the drive current is chosen to give a reasonable signal input to the signal processing subsystem 110 e.g. a reasonable number of ADC counts, without significant distortion of the OLED display screen in detect mode and sufficiently above the noise in release mode.

An example table with two sets of parameters is shown below for a pulsed IR emitter (two 75 µs pulses). The false alarm rate is shown for a system in which the IR emitter drive current does not change (fixed at 10 mA; left hand column of parameters, labelled “Single mode”) and for a system in which the optical energy output is reduced in the release mode (to 8mA; right hand column of parameters, labelled “Detect and release-modes”).

| | Single mode | Detect and release-modes |
|---|---|---|
| IR emitter drive current in detect mode (mA) | 10 | 10 |
| IR emitter drive current in release mode (mA) | 10 | 8 |
| Pulse Length (µs) | 75 | 75 |
| Number of pulses | 2 | 2 |
| Number of Averaging cycles | 4 | 4 |
| ADC detect threshold | 267.8 | 267.83 |
| ADC release threshold | 85.44 | 63.78 |
| Noise | 12.22 | 12.227 |
| Detect threshold - Release threshold | 182.38 | 204.04 |
| Proximity Ratio | 1.58 | 1.79 |
| PPM false trigger rate | 1.99 | 0.07 |

The false trigger rate is significantly improved when using a proximity detection system with detect and release modes and corresponding thresholds as previously described.

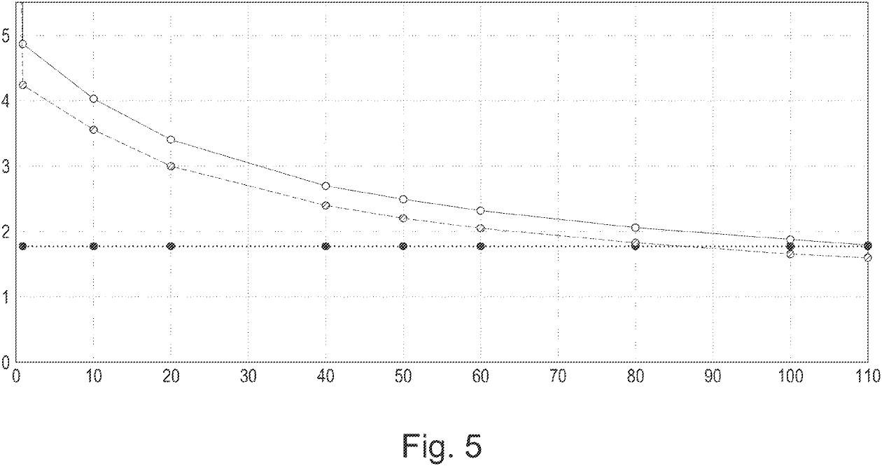

FIG. 5 shows a graph of proximity ratio (Pᵣ) on the y-axis against ambient light level in K-lux on the x-axis. The upper (solid) curve is for a proximity detection system with detect and release-modes as described herein; the lower (dashed) curve is for a single-mode proximity detection system i.e. a system which does not switch between detect and release modes of operation (and corresponding thresholds). The upper curve is for a system in which the IR output is reduced by 20% in the release mode. The horizontal dotted line represents a proximity ratio of 1.78, which corresponds to a 0.1 ppm false trigger rate. The proximity ratio can be thought of as a measure of error tolerance.

FIG. 5 illustrates that a system with detect and release modes of operation can maintain a less than 0.1 ppm false trigger rate up to a high ambient light level (110 K lux), unlike a single mode system.

Features of the system and method which have been described or depicted in combination e.g. in one embodiment, may be implemented separately or in sub-combinations, and features from different embodiments may be combined. Thus each feature disclosed or illustrated in the present specification may be incorporated in the invention, alone or in any appropriate combination with any other feature disclosed or illustrated herein. Features recited in separate dependent claims may be combined. Method steps should not be taken as requiring a particular order e.g. the order in which they are described or depicted, unless this is specifically stated.. A system may be configured to perform a task by providing processor control code and/or dedicated or programmed hardware e.g. electronic circuitry to implement the task. Use of “comprising” does not exclude other elements or steps, and “a” or “an” does not exclude a plurality. Reference signs in the claims should not be construed as limiting the claim scope.

Aspects of the method and system have been described in terms of embodiments but these embodiments are illustrative only and that the claims are not limited to those embodiments.

For example, the crosstalk calibration values P_{offset_detect} and P_{offset_release} may be applied in the analogue rather than in the digital domain, e.g. using an operational amplifier to subtract the crosstalk calibration values from the detector signal.

Although in some implementations of the proximity detection system may be used in a mobile phone e.g. behind the display, in some other implementations the mobile device may be e.g. a pair of earbuds.

Those skilled in the art will be able to make modifications and alternatives in view of the disclosure which are contemplated as falling within the scope of the claims.

1. A proximity detection system for a mobile device, comprising:
an infrared emitter to emit infrared light;
an infrared detector to detect the infrared light after reflection from a target and to provide a detector signal; and
a signal processing subsystem configured to control the proximity detection system into a first, detect mode for detecting proximity of the target as the target approaches the mobile device, and after detection of the target to control the proximity detection system into a second, release mode for detecting movement of the target out of proximity to the mobile device; and wherein
the signal processing subsystem is configured to control the proximity detection system such that for a given proximity of the target the detector signal reduces when the mode switches from the detect mode to the release mode.

2. The system of claim 1 wherein the signal processing subsystem is configured to control the infrared emitter to emit a first level of optical energy in the detect mode and a second, lower level of optical energy in the release mode.

3. The system of claim 2 wherein the signal processing subsystem is programmable to control the optical energy by controlling one or more of a drive level, a number of pulses of the infrared light, a pulse length of the infrared light and, where the system comprises a plurality of the infrared emitters, a number of the infrared emitters used to emit the infrared light.

4. The system of claim 1 wherein the signal processing subsystem is configured to generate a proximity detect signal for the mobile device on detection of proximity of the target to enable the mobile device to perform a post-detect action, and to switch back to the detect mode in response to a detect enable signal from software running on the mobile device that indicates that a post-release action has been performed by the mobile device.

5. The system of claim 4 wherein the proximity detect signal is a detect interrupt signal generated by the signal processing system for the mobile device; and wherein the signal processing subsystem is configured to generate a release interrupt signal for the mobile device when the mode switches from the detect mode to the release mode.

6. The system of claim 1 further comprising a programmable detect threshold register and a programmable release threshold register, wherein in the detect mode the a proximity detect signal for the mobile device on detection of proximity of the target to enable the mobile device to perform a post-detect action, and to switch back to the detect mode in response to a detect enable signal from software signal processing subsystem is configured to compare a value derived from the detector signal with a value in the detect threshold register, and in the release mode the signal processing subsystem is configured to compare a value derived from the detector signal with a value in the release threshold register.

7. The system of claim 1 further configured to store a crosstalk calibration value for each of the detect mode and the release mode, wherein an analogue front end of the system or the signal processing subsystem is configured to apply the respective crosstalk calibration value in each of the detect mode and the release mode.

8. A mobile device comprising the system of claim 1 .

9. The mobile device of claim 8 wherein the mobile device has an OLED display, and wherein one or both of the infrared emitter and the infrared detector is located behind the OLED display.

10. A method of detecting proximity of a target to a mobile device using a proximity detection system, comprising:
illuminating the target with infrared light from an infrared emitter;
detecting reflected light from the target to provide a detector signal;
detecting proximity of the target to the mobile device using the detector signal; then
controlling the proximity detection system to reduce the detector signal; and
detecting movement of the target out of proximity to the mobile device.

11. The method of claim 10 wherein controlling the proximity detection system to reduce the detector signal comprises reducing an optical energy output from the infrared emitter.

12. The method of claim 10 wherein detecting proximity of the target to the mobile device using the detector signal comprises comparing a value derived from the detector signal with a detect threshold, and wherein detecting movement of the target out of proximity to the mobile device comparing a value derived from the detector signal with a release threshold different to the detect threshold.

13. The method of claim 10 further comprising setting a difference between the detect threshold and the release threshold to define a false trigger rate of the proximity detection system.

14. The method of claim 14 wherein the difference between the detect threshold and the release threshold defines a proximity ratio, Pᵣ, according to:
$${P}_{r} = \frac{\left(d e t e c t t h r e s h o l d\right) - \left(r e l e a s e t h r e s h o l d\right)}{6 σ}$$
where σ is the RMS noise level of the detector signal, and wherein setting the difference between the detect threshold and the release threshold to define the false trigger rate comprises selecting a value for Pᵣ according to
$${P}_{r} = \frac{N}{C}$$
where N is a number of standard deviations of a distribution of the noise in the detector signal that defines a probability of false trigger corresponding to the false trigger rate, and C is a constant between 1 and 5.

15. Computer-readable instructions, or one or more computer storage media storing computer-readable instructions, that when executed by one or more computers cause the one or more computers to implement the signal processing subsystem of any of claim 1.

16. Computer-readable instructions, or one or more computer storage media storing computer-readable instructions, that when executed by one or more computers cause the one or more computers to implement the method of claim 10.
